(19) United States
(12) Patent Application Publication
(10) Pub. No.: US 2013/0309541 A1
(43) Pub. Date: Nov. 21, 2013

(54) Protective Sheath

(71) Applicant: Fu-Yi HSU, New Taipei City (TW)

(72) Inventor: Fu-Yi HSU, New Taipei City (TW)

(21) Appl. No.: 13/746,292

(22) Filed: Jan. 21, 2013

(30) Foreign Application Priority Data
May 17, 2012 (TW) 101209343

(51) Int. Cl. H01M 2/02

(52) U.S. Cl. CPC H01M 2/0202
USPC 429/100

(57) ABSTRACT

A protective sheath for a portable electronic device comprising two cover plates, a connection piece and a battery module is provided. The two cover plates respectively have an inner surface. In addition, the two cover plates connect to each other via the connection piece and are capable of being folded relative to each other via the connection piece, so as to enable the two inner surfaces to cover two opposite sides of the portable electronic device respectively. The battery module is disposed to at least one of the two cover plates and has a first connection cable, wherein the first connection cable can be electrically connected with the portable electronic device, so as to enable the battery module to supply electric power to the portable electronic device.

### CROSS-REFERENCE TO RELATED APPLICATIONS

This application claims priority from Taiwan Patent Application No. 101209343, filed May 17, 2012, the contents of which are hereby incorporated by reference in their entirety for all purposes.

### FIELD OF THE INVENTION

The present invention generally relates to a protective sheath, and more particularly to a protective sheath for a portable electronic device.

### DESCRIPTION OF THE RELATED ART

With the development of technology, various portable electronic devices, such as a multimedia player (MP3, MP4 and so on), a cell phone, a personal digital assistant (PDA), a hand-held game console, an electronic book (E-book), a tablet personal computer (tablet PC), a netbook, a notebook and so on, have become an integral part of modern life to many people. To compare with the traditional desktop personal computer (desktop PC), a main advantage of the portable electronic device is easy to get carried. Therefore, in recent years, we can see people operating the portable electronic devices anytime and anywhere.

In order to meet the demands of light, thin, short, small and convenient to carry, the capacity of the battery equipped within the portable electronic device may be sacrificed. As a result, it is necessary to additionally carry a spare battery or an external battery if the user desires to operate the portable electronic device without carrying a power supply or in a place without a power receptacle (for example in outdoor) for a long time.

It should be noted that the commercially available protective sheathes are usually designed for merely receiving the portable electronic device without any individual space for receiving the peripheral devices thereof, such as a spare battery, an external battery, a power supply and so on, and thus both the spare battery and the external battery are inconvenient to be carried together with the portable electronic device. In such a case, if the spare battery or the external battery is forced to be received in the protective sheath together with the portable electronic device, the case of the portable electronic device is likely to be damaged. Further, although some of the commercially available protective bags are designed with an individual space for receiving a spare battery or an external battery, it is inconvenient to supply electric power to the portable electronic device by using the spare battery (or the external battery) as well since both of the portable electronic device and the spare battery (or the external battery) should be took out of the protective bags before being assembled together. As a result, it is desired to provide a new protective sheath convenient to be carried together with the portable electronic device and further capable of supplying electric power to the portable electronic device anytime and anywhere.

### SUMMARY OF THE INVENTION

The present invention is directed to a protective sheath convenient to supply electric power to the portable electronic device.

The present invention provides a protective sheath for a portable electronic device comprising two cover plates, a connection piece and a battery module. The two cover plates respectively have an inner surface. In addition, the two cover plates connect to each other via the connection piece and are capable of being folded relative to each other via the connection piece, so as to enable the two inner surfaces to cover two opposite sides of the portable electronic device respectively. The battery module is disposed to at least one of the two cover plates and has a first connection cable, wherein the first connection cable can be electrically connected with the portable electronic device, so as to enable the battery module to supply electric power to the portable electronic device.

According to an embodiment of the present invention, each one of the cover plates comprises a first inner material layer and a first outer material layer. Herein, the first inner material layer has the inner surface, while the first outer material layer is disposed on a side of the first inner material layer opposite to the inner surface. In a preferred embodiment, each one of the cover plates can further have a lining cushioning material layer disposed between the first inner material layer and the first outer material layer. In another preferred embodiment, the battery module can be disposed between the first inner material layer and the first outer material layer of at least one of the cover plates as well. In a further preferred embodiment, the lining cushioning material layer can be disposed between at least two of the first inner material layer, the battery module and the first outer material layer. In a preferred embodiment, the first inner material layer can be made of not only fiber cloth but also any other similar material not likely to damage the surface of the portable electronic device. In addition, the first outer material layer not only can be made of at least one of metal, plastic, leather, imitation leather, polyurethane (PU) and cloth, but also can be a surface coating layer or just formed by a surface treatment. Moreover, the lining cushioning material layer can be made of not only at least one of petroleum base foaming material, extruded polyethylene (EPE), ethylene vinyl acetate copolymer resin (commonly known as EVA resin or E/VAC resin), styrene butadiene rubber (SBR, commonly known as SBR resin), Standard Chinese Rubber (SCR, commonly known as SCR resin), memory foam and foam rubber, but also any other similar material for buffering.

According to an embodiment of the present invention, one of the two cover plates further has a first fastening portion, while another one of the two cover plates further has a second fastening portion corresponding to the first fastening portion, and the first fastening portion and the second fastening portion are capable of being fastened together when the two cover plates are folded relative to each other. In a further preferred embodiment, the first fastening portion and the second fastening portion are composed of a zipper set, a fastening strap (commonly known as Velcro® strap), a snap button set, a pair of permanent magnets with opposite magnet polarities, a combination of a permanent magnet and a ferromagnetic material artifact, a combination of a hook and a locking aperture, a combination of a pin and an inserting aperture, and a combination listed above.

According to an embodiment of the present invention, the connection piece comprises a second inner material layer and a second outer material layer, wherein the second outer material layer is disposed on a side of the second inner material layer opposite to the portable electronic device. In a preferred embodiment, the first connection cable can be embedded between the second inner material layer and the second outer material layer, pass through the second inner material layer, and extend to where between the inner surfaces. In another preferred embodiment, the battery module can also have a second connection cable capable of electrically connecting with an external power source, so as to enable the battery module to be charged by the external power source, and the second connection cable can be embedded between the second inner material layer and the second outer material layer, pass through the second outer material layer, and extend outward. In a preferred embodiment, the first inner material layer can be made of not only fiber cloth but also any other similar material not likely to damage the surface of the portable electronic device. In addition, the first outer material layer can be made of at least one of metal, plastic, leather, imitation leather, PU and cloth.

According to an embodiment of the present invention, the connection piece is a hollow shaft, while the first connection cable is embedded within the hollow shaft, passes through the hollow shaft, and extends to where between the inner surfaces. In a preferred embodiment, the battery module can further have a second connection cable capable of electrically connecting with an external power source, so as to enable the battery module to be charged by the external power source, and the second connection cable can be embedded within the hollow shaft, pass through the hollow shaft, and extend outward.

According to an embodiment of the present invention, the protective sheath further comprises a holding piece disposed adjacent to the connection piece and capable of holding the first connection cable on one of the inner surfaces or between the inner surfaces. In a preferred embodiment, the holding piece can be at least one of an elastic, a fastening strap, a container, an adhesive unit and a hook.

According to an embodiment of the present invention, the portable electronic device is a netbook or a notebook.

Accordingly, since there is a battery module embedded within the protective sheath of the present invention and the battery module can be electrically connected with the portable electronic device via the first connection cable thereof, the protective sheath can not only be used to protect the portable electronic device, but also to supply electric power to the portable electronic device via the battery module embedded therein anytime and anywhere. Besides, the protective sheath can also supply electric power to the portable electronic device without taking the portable electronic device out of the protective sheath if the first connection cable passes through the connection piece and extends to where between the two inner surfaces. In addition, the battery module can further be electrically connecting with the external power source via the second connection cable passing through the connection piece and extending outward, so as to enable the battery module to be charged by the external power source.

### BRIEF DESCRIPTION OF THE DRAWINGS

FIG. 1 illustrates a structural schematic top view of a protective sheath according to an embodiment of the present invention, wherein a portable electronic device is received.

FIG. 2 illustrates a cross-sectional view of the protective sheath along the line I-I as illustrated in FIG. 1.

FIG. 3 illustrates a cross-sectional view of the protective sheath as illustrated in FIG. 1, wherein both of the protective sheath and the portable electronic device are unfolded.

FIG. 4 illustrates a structural schematic cross-sectional view of a protective sheath according to another embodiment of the present invention, wherein a portable electronic device is received.

### DETAILED DESCRIPTION OF THE INVENTION

Reference will now be made in detail to specific embodiments of the present invention. Examples of these embodiments are illustrated in the accompanying drawings. While the invention will be described in conjunction with these specific embodiments, it will be understood that it is not intended to limit the invention to these embodiments. In fact, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known process operations are not described in detail in order not to obscure the present invention.

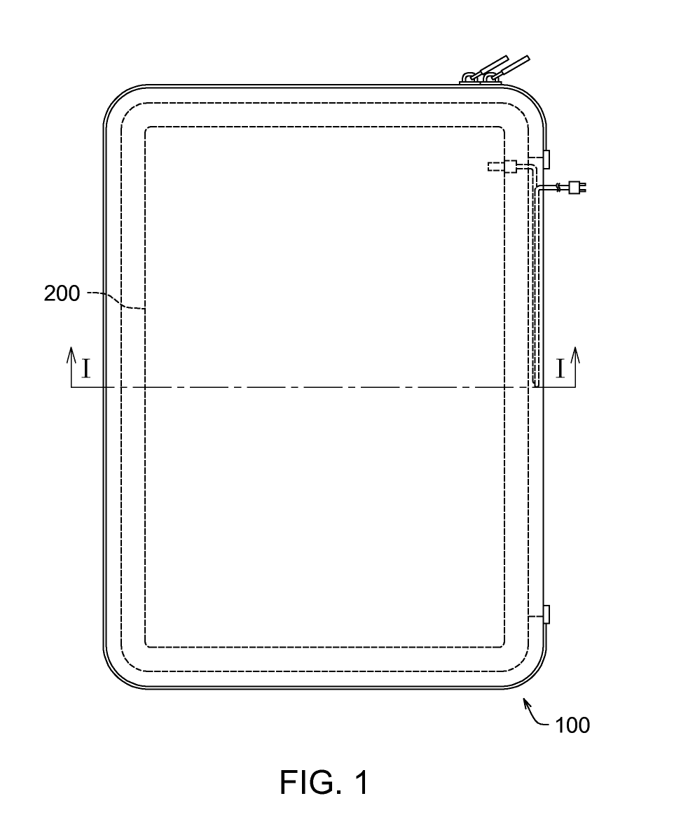

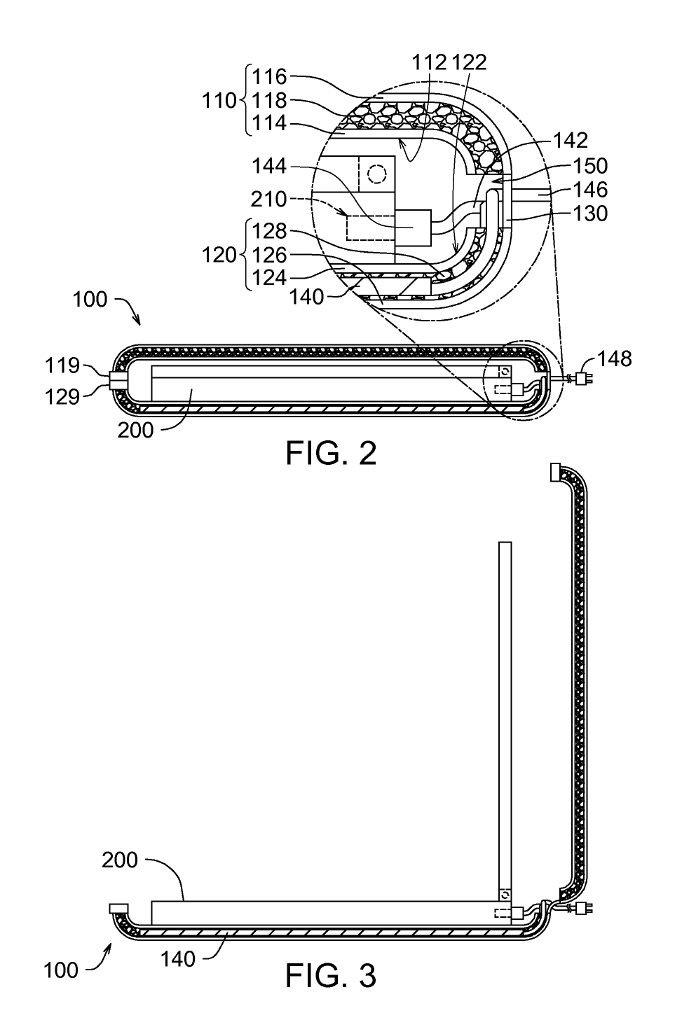

FIG. 1 illustrates a structural schematic top view of a protective sheath according to an embodiment of the present invention, wherein a portable electronic device is received. In addition, FIG. 2 illustrates a cross-sectional view of the protective sheath along the line I-I as illustrated in FIG. 1. Furthermore, FIG. 3 illustrates a cross-sectional view of the protective sheath as illustrated in FIG. 1, wherein both of the protective sheath and the portable electronic device are unfolded. In the following embodiments, the same or similar components illustrated in different embodiments refer to the same symbols. Besides, all of the upper side, the lower side, the left side and the right side described in the present embodiment refer to the orientation of FIG. 2.

Referring to FIG. 1 and FIG. 2 together first, the protective sheath 100 provided in the present invention can be used for receiving a portable electronic device 200. In the present preferred embodiment, the portable electronic device 200 is exemplarily illustrated in detail as a notebook or a netbook. However, in other non-illustrated embodiments, the protective sheath 100 can further be used for receiving various portable electronic devices, such as a multimedia player (MP3, MP4 and so on), a cell phone, a PDA, a hand-held game console, an E-book, a tablet PC and so on.

The protective sheath 100 in the present embodiment comprises an upper cover plate 110, a lower cover plate 120, a connection piece 130 and a battery module 140. The upper cover plate 110 has an inner surface 112, and the lower cover plate 120 has an inner surface 122 as well. Besides, the upper cover plate 110 and the lower cover plate 120 are connected to each other, and capable of being folded relative to each other via the connection piece 130, so as to enable the two inner surfaces 112 and 122 to cover an upper side and a lower side of the portable electronic device 200 respectively. Furthermore, the battery module 140 is, for example but not limited to, embedded within the lower cover plate 120, and has a connection cable 142. Moreover, the battery module 140 can be electrically connected with the portable electronic device 200 via the connection cable 142, so as to supply the electric power to the portable electronic device 200. In other non-illustrated embodiments, the battery module can be embedded within the upper cover plate only, or embedded within both of the upper cover plate and the lower cover plate.

In detail, in the present preferred embodiment, the upper cover plate 110 is laminated, for example but not limited to, by an inner material layer 114, an outer material layer 116 and a lining cushioning material layer 118. Herein, the inner material layer 114 is located at a side of the upper cover plate 110 facing the portable electronic device 200, and has an inner surface 112, while the outer material layer 116 is located at another side of the upper cover plate 110 distant from the portable electronic device 200. In addition, the lining cushioning material layer 118 is disposed between the inner material layer 114 and the outer material layer 116. However, in other non-illustrated embodiments, the upper cover plate can also be formed by a single inner material layer, i.e. the upper cover plate does not comprise an outer material layer and a lining cushioning material layer. Alternatively, the upper cover plate can be laminated by an inner material layer and an outer material layer without comprising a lining cushioning material layer as well.

In the present preferred embodiment, the first inner material layer 114 can be made of not only fiber cloth but also any other similar material not likely to damage the surface of the portable electronic device 200. In addition, the first outer material layer 116 can be made of at least one of metal, plastic, leather, imitation leather, PU and cloth. Moreover, the lining cushioning material layer 118 can be made of various material for buffering, for example but not limited to, petroleum base foaming material, extruded polyethylene (EPE), ethylene vinyl acetate copolymer resin (commonly known as EVA resin or E/VAC resin), styrene butadiene rubber (SBR, commonly known as SBR resin), Standard Chinese Rubber (SCR, commonly known as SCR resin), memory foam and foam rubber.

Further, the lower cover plate 120 can be laminated, for example but not limited to, by an inner material layer 124, an outer material layer 126 and a lining cushioning material layer 128, too, and the battery module 140 can be embedded within the lining cushioning material layer 128, i.e. the lining cushioning material layer 128 is not only disposed between the inner material layer 124 and the battery module 140, but also disposed between the outer material layer 126 and the battery module 140. Herein, all of the lamination and the materials of the inner material layer 124, the outer material layer 126 and the lining cushioning material layer 128 are substantially similar to those of the inner material layer 114, the outer material layer 116 and the lining cushioning material layer 118 of the upper cover plate 110, and thus are omitted herein. Similarly, in other non-illustrated embodiments, the lower cover plate can also be laminated by an inner material layer and an outer material layer without comprising a lining cushioning material layer as well. In such a case, the battery module can further be embedded between the inner material layer and the outer material layer.

Also, the connection piece 130 of the present preferred embodiment is, for example but not limited to, a single material layer integrally formed with the outer material layer 116 and the outer material layer 126. In a word, the connection piece 130 is connected between the two outer material layers 116 and 126, and the material thereof is substantially the same as those of the two outer material layers 116 and 126. Alternatively, in other non-illustrated embodiments, to the upper cover plate, the outer material layer can also be a surface coating layer on an outer surface of the inner material layer, or can be just a material layer formed by a surface treatment to the outer surface of the inner material layer. In such an instance, the connection piece can be made of various flexible materials, for example but not limited to, metal, plastic, leather, imitation leather, PU and cloth, so as to enable the upper cover plate and the lower cover plate to be folded and unfolded relative to each other.

Besides, the connection cable 142, for example but not limited to, extends from the battery module 140, passes through the lining cushioning material layer 128 and then extends into a trench 150 formed among the upper cover plate 110, the lower cover plate 120 and the connection piece 130, and a plug 144 located on an end thereof is capable of being plugged in a power cord jack 210 of the portable electronic device 200. As a result, the battery module 140 can supply the electric power to the portable electronic device 200 not only when the portable electronic device 200 is enclosed within the protective sheath 100 as illustrated in FIG. 2, but also when the portable electronic device 200 is operated on the protective sheath 100 as illustrated in FIG. 3.

Also, referring to FIG. 2, the battery module 140 can further have another connection cable 146, wherein the connection cable 146, for example but not limited to, extends from the battery module 140, passes through the lining cushioning material layer 128, extends to the trench 150, passes through the connection piece 130, and then extends out of the protective sheath 100 in sequence, and a plug 148 located on an end thereof is capable of being further electrically connected with an external power source (not shown). As a result, the battery module 140 can be charged via the external power source in an instance as illustrated in FIG. 2, in an instance as illustrated in FIG. 3, or when the protective sheath 100 do not receive the portable electronic device 200 therein.

Furthermore, as illustrated in FIG. 2, in the present preferred embodiment, the upper cover plate 110 can further have a fastening portion 119, and the lower cover plate 110 can further have another fastening portion 129. In addition, the two fastening portions 119 and 129 are arranged correspondingly and capable of be fastened together when the upper cover plate 110 and the lower cover plate 120 are folded relative to each other, so as to enclose the portable electronic device 200 within the protective sheath 100 securely. The two fastening portions 119 and 129 can be composed of not only a zipper set as illustrated in FIG. 1, FIG. 2 and FIG. 3, but also a fastening strap (commonly known as Velcro® strap), a snap button set, a pair of permanent magnets with opposite magnet polarities, a combination of a permanent magnet and a ferromagnetic material artifact, a combination of a hook and a locking aperture, a combination of a pin and an inserting aperture, and a combination listed above.

It should be noted that, in other non-illustrated embodiments, the connection cable for electrically connecting with the portable electronic device can further pass through the lining cushioning material layer and the inner material layer directly, and extend into the protective sheath. Also, the protective sheath can further comprise a holding piece disposed adjacent to the connection piece and capable of holding the connection cable on the inner surface of the upper cover plate or the lower cover plate. Similarly, the connection cable capable of electrically connecting with the external power source can pass through the lining cushioning material layer and the outer material layer directly, and extend into the protective sheath as well. In addition, the protective sheath can further comprise another holding piece disposed adjacent to the connection piece and capable of holding the connection cable on the outer surface of the upper cover plate or the lower cover plate. Herein, each of the holding pieces can be at least one of an elastic, a fastening strap (commonly known as Velcro® strap), a dent, an adhesive piece and a hook. Besides, both of the two connection cables can also be embedded within the connection piece together as illustrated in the following embodiment.

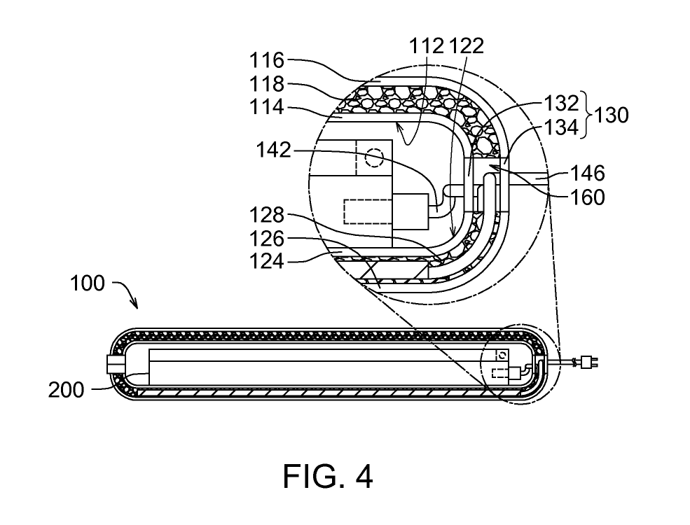

FIG. 4 illustrates a structural schematic cross-sectional view of a protective sheath according to another embodiment of the present invention, wherein a portable electronic device is received. Referring to FIG. 4, the connection piece 130 is laminated, for example but not limited to, by an inner material layer 132 and an outer material layer 134. Herein, the inner material layers 132, 114 and 124 are formed integrally, and the outer material layers 134, 116 and 126 are formed integrally as well. In another word, the inner material layer 132 is connected between these two inner material layers 114 and 124, and a material thereof is substantially the same as those of these two inner material layers 114 and 124, while the outer material layer 134 is connected between these two outer material layers 116 and 126, and a material thereof is substantially the same as those of these two inner material layers 116 and 126. Moreover, both of the two connection cables 142 and 146 are embedded within a containing space 160 formed among the lining cushioning material layers 118 and 128, the inner material layer 132 and the outer material layer 134.

In the present embodiment, the connection cable 142, for example but not limited to, passes through the inner material layer 132 from the containing space 160 and then extends to where between these two inner surfaces 112 and 122, so as to electrically connect with the portable electronic device 200. In contrast, the connection cable 146, for example but not limited to, passes through the outer material layer 134 from the containing space 160 and then extends out of the protective sheath 100, so as to electrically connect with the external power source.

Besides, in other non-illustrated embodiments, the connection piece 130 in the present preferred embodiment can further be replaced by a hollow shaft. Similarly, in such a case, both of the two connection cables 142 and 146 can be embedded within the hollow shaft, pass through the hollow shaft, and then further respectively extend to an interior and an exterior of the protective sheath 100.

In summary, since there is a battery module embedded within the protective sheath provided by the present invention and the battery module can be electrically connected with the portable electronic device via the connection cable thereof, the protective sheath can not only be used to protect the portable electronic device, but also to supply electric power to the portable electronic device via the battery module embedded therein anytime and anywhere. Also, the battery module can be electrically connected with the portable electronic device via the connection cable extending to the interior of the protective sheath, so that the protective sheath can supply electric power to the portable electronic device with or without taking the portable electronic device out of the protective sheath. In addition, the battery module can further be electrically connecting with the external power source via the connection cable passing through the connection piece and extending to the exterior of the protective sheath, so as to enable the battery module to be charged by the external power source.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A protective sheath for a portable electronic device, comprising:
two cover plates, respectively having an inner surface;
a connection piece, the cover plates connecting to each other via the connection piece, and capable of being folded relative to each other via the connection piece, so as to enable the inner surfaces to cover two opposite sides of the portable electronic device respectively; and
a battery module, disposed to at least one of the cover plates, and having a first connection cable, wherein the first connection cable is capable of electrically connected with the portable electronic device, so as to enable the battery module to supply electric power to the portable electronic device.

2. The protective sheath as claimed in claim 1, wherein each one of the cover plates comprises:
a first inner material layer, having the inner surface; and
a first outer material layer, disposed on a side of the first inner material layer opposite to the inner surface.

3. The protective sheath as claimed in claim 2, wherein each one of the cover plates further has a lining cushioning material layer disposed between the first inner material layer and the first outer material layer.

4. The protective sheath as claimed in claim 2, wherein the battery module is disposed between the first inner material layer and the first outer material layer of at least one of the cover plates.

5. The protective sheath as claimed in claim 4, wherein each one of the cover plates further comprises a lining cushioning material layer disposed between at least two of the first inner material layer, the battery module and the first outer material layer.

6. The protective sheath as claimed in claim 1, wherein one of the cover plates further has a first fastening portion, while another one of the cover plates further has a second fastening portion corresponding to the first fastening portion, and the first fastening portion and the second fastening portion are capable of being fastened together when the cover plates are folded relative to each other.

7. The protective sheath as claimed in claim 6, wherein the first fastening portion and the second fastening portion are composed of a zipper set, a fastening strap, a snap button set, a pair of permanent magnets with opposite magnet polarities, a combination of a permanent magnet and a ferromagnetic material artifact, a combination of a hook and a locking aperture, a combination of a pin and an inserting aperture, and a combination listed above.

8. The protective sheath as claimed in claim 1, wherein the connection piece comprises:
a second inner material layer; and
a second outer material layer, disposed on a side of the second inner material layer opposite to the portable electronic device.

9. The protective sheath as claimed in claim 8, wherein the first connection cable is embedded between the second inner material layer and the second outer material layer, passes through the second inner material layer, and extends to where between the inner surfaces.

10. The protective sheath as claimed in claim 8, wherein the battery module further has a second connection cable capable of electrically connecting with an external power source, so as to enable the battery module to be charged by the external power source, and the second connection cable is embedded between the second inner material layer and the second outer material layer, passes through the second outer material layer, and extends outward.

11. The protective sheath as claimed in claim 1, wherein the connection piece is a hollow shaft, while the first connection cable is embedded within the hollow shaft, passes through the hollow shaft, and extends to where between the inner surfaces.

12. The protective sheath as claimed in claim 11, wherein the battery module further has a second connection cable capable of electrically connecting with an external power source, so as to enable the battery module to be charged by the external power source, and the second connection cable is embedded within the hollow shaft, passes through the hollow shaft, and extends outward.

13. The protective sheath as claimed in claim 1, further comprising a holding piece, wherein the holding piece is disposed adjacent to the connection piece, and capable of holding the first connection cable on one of the inner surfaces or between the inner surfaces.

14. The protective sheath as claimed in claim 13, wherein the holding piece is at least one of an elastic, a fastening strap, a container, an adhesive unit and a hook.

15. The protective sheath as claimed in claim 1, wherein the portable electronic device is a netbook or a notebook.
